(19) United States
(12) Patent Application Publication
(10) Pub. No.: US 2026/0100183 A1
(43) Pub. Date: Apr. 9, 2026

(54) METHOD AND SYSTEM FOR PRODUCING SYNTHESIZED SPEECH DIGITAL AUDIO CONTENT

(71) Applicant: VOISEED S.R.L., Milano (IT)

(72) Inventor: Lorenzo TARANTINO, Milano (IT)

(21) Appl. No.: 19/113,174

(22) PCT Filed: Sep. 27, 2023
(86) PCT No.: PCT/IB2023/059611

§ 371 Date: Mar. 19, 2025

(30) Foreign Application Priority Data
Sep. 27, 2022 (IT) 102022000019788

(51) Int. Cl. G10L 13/047; G10L 13/033; G10L 13/06; G10L 13/10; G10L 15/02

(52) U.S. Cl. CPC G10L 13/047; G10L 13/0335; G10L 13/06; G10L 13/10; G10L 15/02; G10L 2013/105; G10L 2015/025

(57) ABSTRACT

A method for producing synthesized speech digital audio content, wherein:
a feature extractor module receives an audio recording of a speaker's voice, extracts a plurality of acoustic features and converts them to an audio latent representation matrix;
a phonemizing module receives as input a target text and converts the target text to a sequence of phonemes;
a tokenizing module receives as input the sequence of phonemes of the target text;
a linguistic encoder module receives as input the sequence of phoneme vectors and converts the sequence of phoneme vectors to a sequence of respective linguistic latent vectors;
an acoustic model module produces a predicted audio latent representation matrix; and
a vocoder module decodes the predicted audio latent representation matrix into the corresponding audio signal of the speech of the synthesized virtual voice.

The present application is a U.S. national stage entry under 35 U.S.C. § 371 of PCT International Patent Application No. PCT/IB2023/059611, filed Sep. 27, 2023, which in turn claims priority to Italian Patent Application No. 102022000019788, filed Sep. 27, 2022, the entirety of each of which are incorporated herein by reference.

The present invention relates to a method and a system for producing synthesized speech digital audio content, commonly known as synthesized speech.

Within the present invention, and therefore in the present description, the expression “synthesized speech digital audio content” indicates a digital audio content (or file) which contains a spoken speech resulting from a process of speech synthesis, where a virtual voice, i.e. a digitally-simulated human voice, recites a target text.

The method and the system according to the present invention are particularly, although not exclusively, useful and practical in the practice of dubbing, i.e. the recording or production of the voice, or rather of the speech, which, in preparing the soundtrack of an audiovisual content, is done at a stage after the shooting or production of the video. Dubbing is an essential technical operation when the audiovisual content is to have the speech in a language other than the original, when the video has been shot outdoors and in conditions unfavorable for recording speech and, more generally, in order to have better technical quality.

Currently, known Text-To-Speech systems comprise two main modules: the acoustic model and the vocoder.

The acoustic model is configured to receive as input: acoustic features, i.e. a set of information relating to the speech of a speaker's voice, where this information describes the voice of the speaker himself or herself, the prosody, the pronunciation, any background noise, and the like; and linguistic features, i.e. a target text that the synthesized virtual voice is to recite.

The acoustic model is further configured to predict the audio signal of the speech of the synthesized virtual voice, producing as output a representation matrix of that audio signal. Typically, this representation matrix is a spectrogram, for example the mel spectrogram.

In general, a signal is represented in the time domain by means of a graph that shows time on the abscissa and voltage, current, etc. on the ordinate. In particular, in the present invention, an audio signal is represented in the time domain by a graph that shows time on the abscissa and the intensity or amplitude of that audio signal on the ordinate.

In general, a spectrogram is a physical/visual representation of the intensity of a signal over time in the various frequencies present in a waveform. In particular, in the present invention, a spectrogram is a physical/visual representation of the intensity of the audio signal over time that considers the frequency domain of that audio signal; the advantage of this type of representation of the audio signal is that it is easier for deep learning algorithms to interpret this spectrogram than to interpret the audio signal as such. The mel spectrogram is a spectrogram wherein the sound frequencies are converted to the mel scale, a scale of perception of the pitch, or “tonal height”, of a sound.

The vocoder is configured to receive as input the representation matrix, for example the mel spectrogram, of the audio signal of the speech of the synthesized virtual voice, produced by the acoustic model, and to convert, or rather decode, this representation matrix into the corresponding audio signal of the speech of the synthesized virtual voice.

Regarding voice cloning, the best known Text-To-Speech systems are known as “single-speaker” systems, and comprise an acoustic model and a vocoder which are configured to reproduce a single voice, i.e. the voice of just one speaker. These single-speaker systems are trained using datasets of the voice of a single speaker which contain generally at least 20 hours of audio recording, preferably high quality.

Other known Text-To-Speech systems that succeed in achieving an excellent quality of voice cloning are known as “multi-speaker” systems, and comprise an acoustic model and a vocoder which are configured to reproduce a plurality of voices, i.e. the voices of a plurality of speakers. These multi-speaker systems are trained using datasets of the voices of a plurality of speakers which contain generally hundreds of hours of audio recording, preferably high quality, with at least 2-4 hours for each speaker's voice.

Regarding the expressiveness of the synthesized virtual voice, in known Text-To-Speech systems, the prosody, i.e. the set comprising pitch, rhythm (isochrony), duration (quantity), accent of the syllables of the spoken language, emotions and emissions, can be “controlled” in two ways: by means of acoustic features extracted from the audio recordings of the voices, or by means of categorical inputs, for example emotional inputs. In turn, the acoustic features can be created manually (handcrafted), or without supervision (unsupervised).

Handcrafted acoustic features are features that are extracted manually from audio recordings and which have a physical and describable valency, for example the pitch or “tonal height”, i.e. the fundamental frequency F₀, and the energy, i.e. the magnitude of a frame of the spectrogram.

When audio is converted from a signal to a spectrogram, the signal is compressed over time. For example, an audio clip of 1 second at 16 kHz on 1 channel, therefore with the dimensions [1, 16000], can be converted to a spectrogram with the dimensions [80, 64], where 80 is the number of frequency buckets and 64 is the number of frames. Each frame represents the intensity of 80 buckets of frequencies for a period of time equal to 1 s/64, or rather 16000/64. Therefore, in practice, one frame of the spectrogram can be defined as a set of acoustic features on a window, or a segment of audio signal.

Unsupervised acoustic features are features that are extracted from audio recordings by means of models that use latent spaces, which can be variational, and bottlenecks on the audio encoders, for example the Global Style Token (GST).

Regarding the audio quality of the synthesized virtual voice, which in known Text-To-Speech systems is often evaluated using subjective metrics, for example Mean Opinion Score (MOS), there is a clear compromise between the number of functionalities of acoustic models and of vocoders, and the quality of the resulting audio signal. Basically, the greater the expressiveness of the voice, the number of voices supported and the number of languages supported, the lower the quality of the resulting audio signal, for the same number of parameters.

However, these Text-To-Speech systems of known type are not devoid of drawbacks, among which is the fact that, in voice cloning, both single-speaker systems and multi-speaker systems are limited to using the specific voices learned during training. In other words, the number of voices available in known Text-To-Speech systems is limited, with a consequent reduction of the possible uses for these systems.

Another drawback of known Text-To-Speech systems consists in that voice cloning requires an audio recording session in a studio for each voice to be cloned, in order to create the training datasets.

Furthermore, known Text-To-Speech systems do not offer effective solutions for multiple languages, mainly owing to the scarcity of audio recordings to learn from in languages other than English. Furthermore, the audio recording of the voice of each speaker can be used only for his or her respective mother tongue. In other words, each speaker is associated with a single language, therefore a plurality of speakers is necessary for multiple languages. This lack of multilingual solutions limits the scalability of these systems even further.

The extraction of handcrafted acoustic features from audio recordings of voices has the drawback of not being able to describe all the nuances and facets of the prosody of the spoken language. The solution to this drawback is the extraction of unsupervised acoustic features, which however has the drawback of being neither intelligible nor controllable.

Furthermore, in general, known Text-To-Speech systems are not capable of reproducing a wide emotional/expressive range, mainly owing to the scarcity of audio recordings to learn from.

Often there is also the problem that the audio recordings of the voices used to train the known Text-To-Speech systems are not of sufficient quality, in terms both of sampling frequency and of clean audio signal, in order to obtain a result with high audio quality. The solution to this problem is deep learning algorithms, which are developed to give superior audio quality, but which are slow in their inference and, especially, are very complex to train.

The aim of the present invention is to overcome the limitations of the known art described above, by devising a method and a system for producing synthesized speech digital audio content that make it possible to obtain better effects than those that can be obtained with conventional solutions and/or similar effects at lower cost and with higher performance levels.

Within this aim, an object of the present invention is to devise a method and a system for producing synthesized speech digital audio content that make it possible to create acoustic and linguistic features optimized for the acoustic model, as well as to create optimized audio representation matrices.

Another object of the present invention is to devise a method and a system for producing synthesized speech digital audio content that make it possible to synthesize a virtual voice while maximizing the expressiveness and naturalness of that virtual voice.

Another object of the present invention is to devise a method and a system for producing synthesized speech digital audio content that make it possible, given an audio recording of a source voice, even of short duration (a few seconds), to imitate the expressiveness of the source voice, in practice transferring the style of the source voice to the synthesized virtual voice.

Another object of the present invention is to devise a method and a system for producing synthesized speech digital audio content that make it possible, given an audio recording of a source voice, even of short duration (a few seconds), to create a completely synthesized voice that reflects the main features of the source voice, in particular of its voice timbre.

Another object of the present invention is to devise a method and a system for producing synthesized speech digital audio content that have multilingual capability, i.e, wherein every synthesized virtual voice can speak in every supported language.

Another object of the present invention is to provide a method and a system for producing synthesized speech digital audio content that are highly reliable, easily and practically implemented, and economically competitive when compared to the known art.

This aim and these and other objects which will become more apparent hereinafter are achieved by a method for producing synthesized speech digital audio content according to claim 1.

The aim and objects are also achieved by a synthesized speech digital audio content according to claim 10.

The aim and objects are also achieved by a system for producing synthesized speech digital audio content according to claim 11.

Further characteristics and advantages of the present invention will become better apparent from the description of a preferred, but not exclusive, embodiment of the method and of the system for producing synthesized speech digital audio content according to the invention, illustrated by way of non-limiting example with the assistance of the accompanying drawings, wherein:

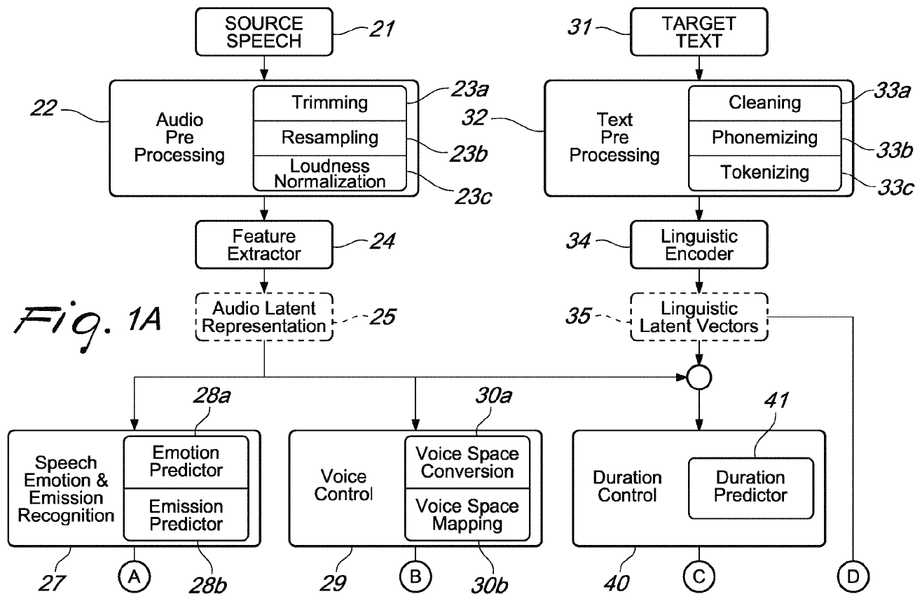

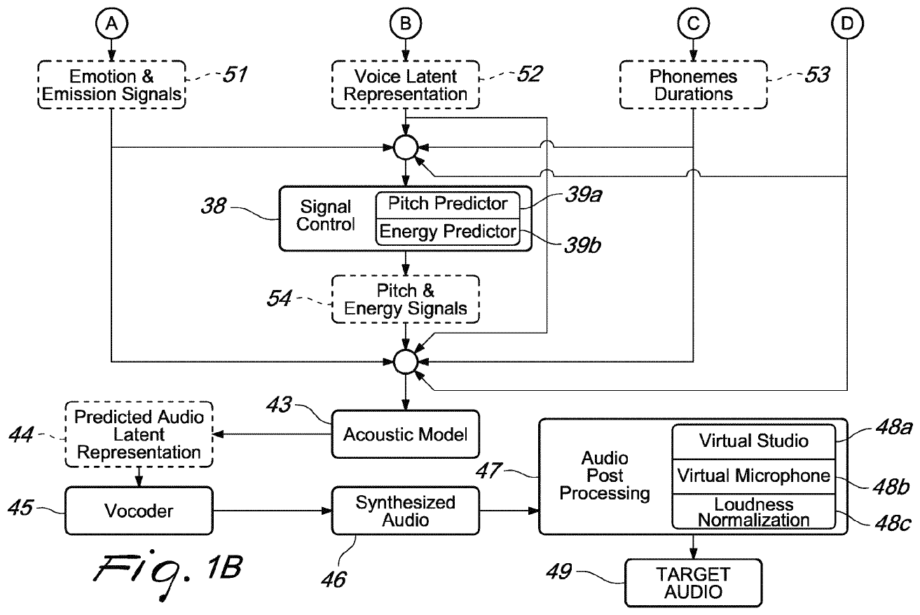

FIGS. 1A and 1B are a flowchart that shows a first variant, or inference variant, of an embodiment of the method for producing synthesized speech digital audio content according to the present invention;

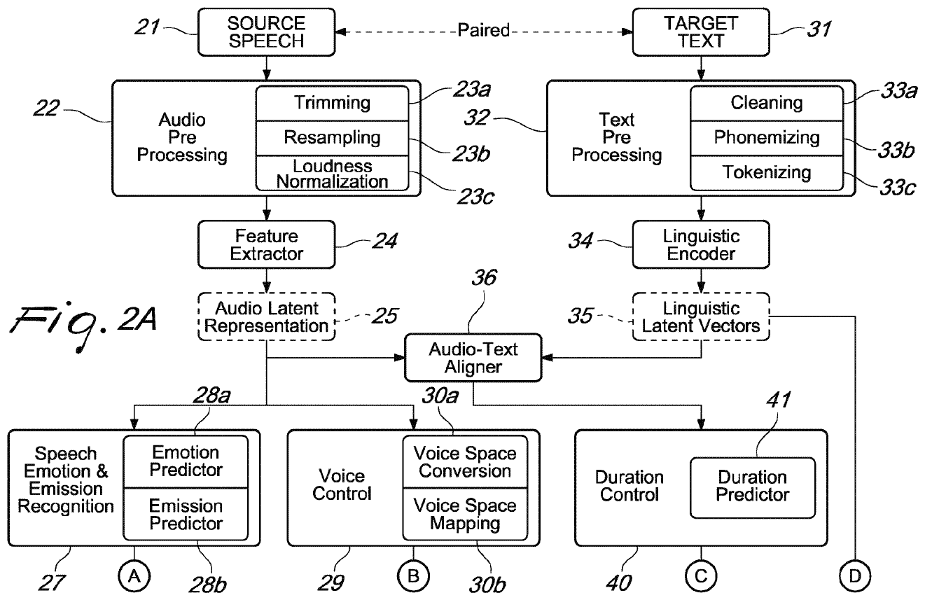

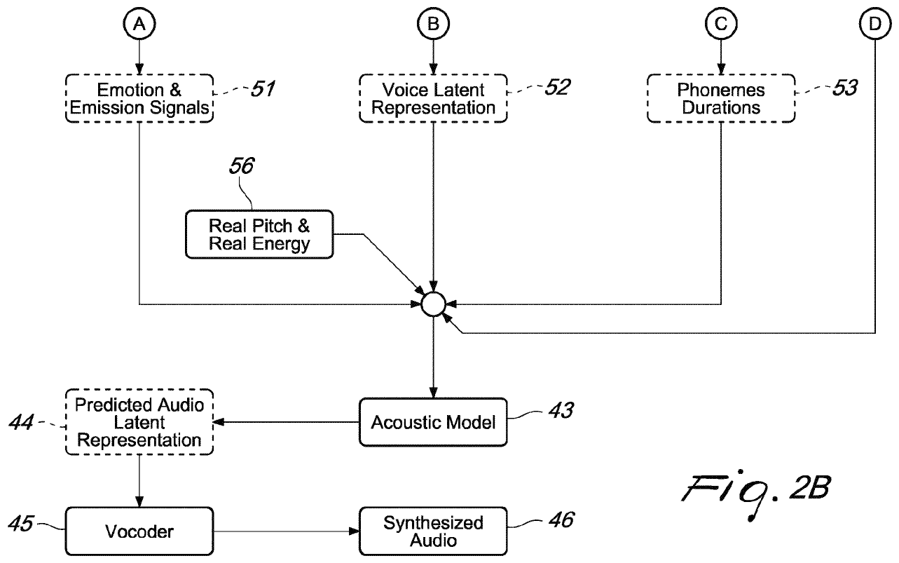

FIGS. 2A and 2B are a flowchart that shows a second variant, or training variant, of an embodiment of the method for producing synthesized speech digital audio content according to the present invention;

FIG. 3 is a schematic diagram of a part of the operation of an embodiment of the method for producing synthesized speech digital audio content according to the present invention;

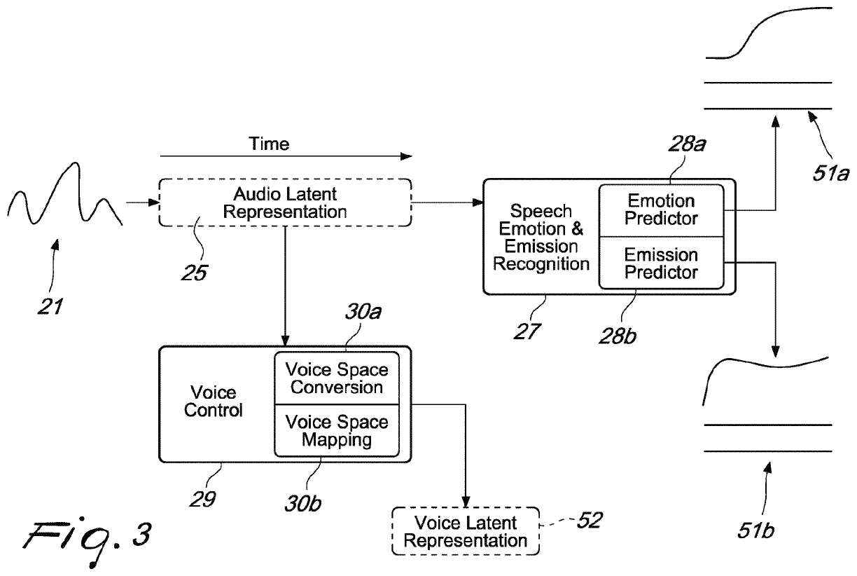

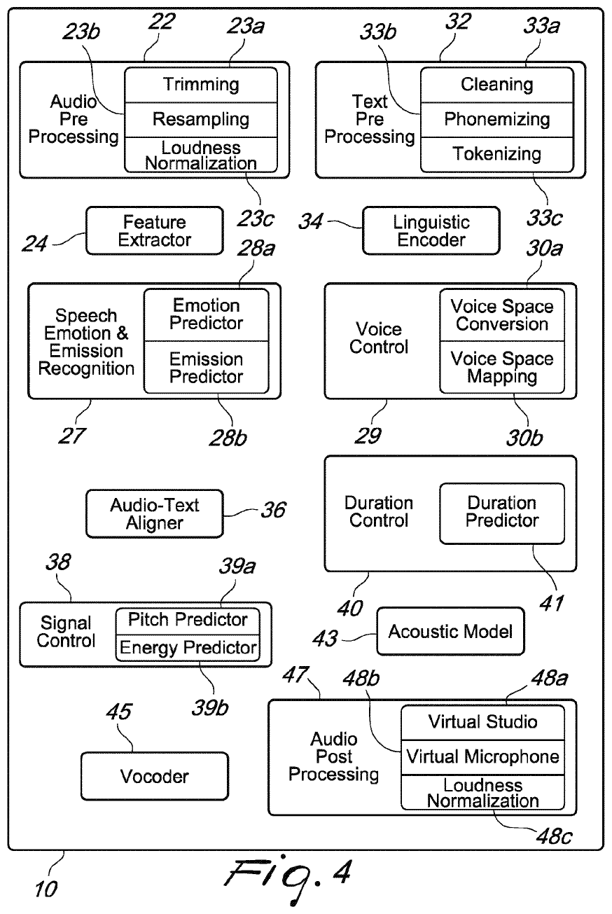

FIG. 4 is a block diagram schematically showing an embodiment of the system for producing synthesized speech digital audio content according to the present invention;

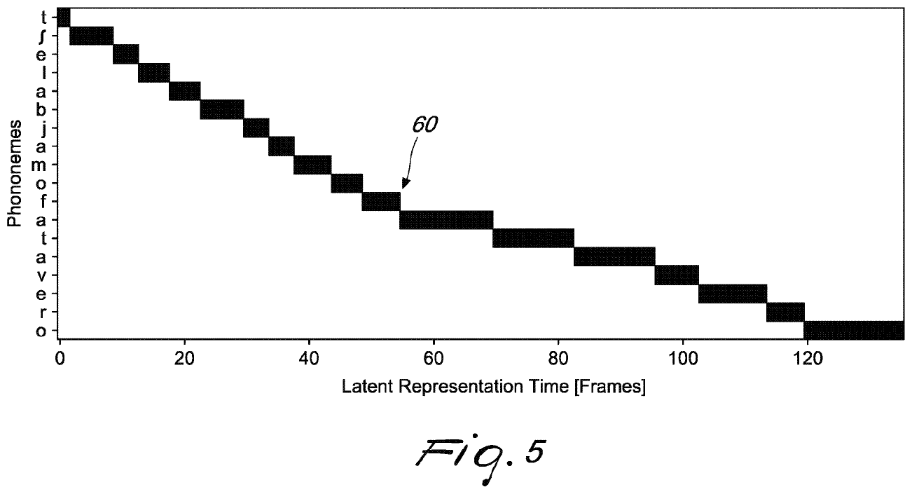

FIG. 5 is a graph showing an example of trend of the alignment over time of the phonemes of a target text with the latent representation of the audio signal.

With reference to FIGS. 1A to 3, the method for producing synthesized speech digital audio content according to the present invention comprises the steps described below.

Preliminarily, it should be noted that, in an embodiment, in particular in the inference variant of the method according to the invention, illustrated in FIGS. 1A and 1B, the method according to the invention has, as input from which to synthesize the virtual voice, an audio recording 21 over time of any speech of the speaker's voice (source speech or reference speech), in practice an audio signal from which the voice and expression are obtained, and a target text 31 which the synthesized virtual voice is to recite.

Preliminarily, it should be noted that, in an embodiment, in particular in the training variant of the method according to the invention, illustrated in FIGS. 2A and 2B, the method according to the invention has, as input from which to train the trainable modules, an audio recording 21 over time of a specific speech of the speaker's voice (source speech or reference speech), in practice an audio signal from which the voice and expression are learned, and a target text 31 which corresponds to the speech of the speaker's voice. Basically, the speech of the speaker's voice comprises the pronunciation of the target text. In other words, the speech of the speaker's voice and the target text are paired or aligned. In the training variant of the method according to the invention, illustrated in FIGS. 2A and 2B, the method according to the invention furthermore has, as input, a plurality of real pitch and real energy signals 56 relating to the audio recording 21.

Preliminarily, it should also be noted that the blocks 25, 35, 51, 52, 53, 54 and 44 shown in dotted lines in FIGS. 1A to 2B represent matrices and/or vectors resulting from operations executed by the respective modules.

A feature extractor module 24 receives as input the audio recording 21, as acquired or preprocessed, extracts a plurality of acoustic features from that audio recording 21, and transforms or converts these acoustic features to an audio latent representation matrix 25 over time. In particular, the feature extractor module 24 transforms or converts the audio recording 21 with time dimension N to an audio latent representation matrix 25 with a dimension of D×M, where D is the number of acoustic features of the audio recording 21 and M is the compressed time dimension of the audio recording 21.

The feature extractor module 24 produces as output the audio latent representation matrix 25. This feature extractor module 24 is a trainable module, in particular by means of self-supervised training, which implements a deep learning algorithm.

In general, in the present invention, the latent representation is a representation matrix of real numbers learned and extracted by a trained module. The audio latent representation matrix 25 is a matrix of acoustic features of the audio recording 21 that has more “explicative properties” than the audio recording 21 as such.

The audio latent representation matrix 25 is a different representation of the audio signal with respect to the spectrogram. The audio latent representation matrix 25 condenses the acoustic features of the audio recording 21 into a more compact form and one that is more intelligible to computers, but less so for humans.

The audio latent representation matrix 25 is a time-dependent matrix and contains information relating to the speech of the audio recording 21 that is extremely intelligible to the modules of the subsequent steps. The audio latent representation matrix 25, produced by the feature extractor module 24, is used as input by the modules of the subsequent steps.

Preferably, the audio recording 21, before being received as input by the feature extractor module 24, can be processed by an audio preprocessing module 22. The audio preprocessing module 22 receives as input the audio recording 21 of the speech of the speaker's voice, i.e. an audio signal of the speech of the speaker's voice, as acquired.

The audio preprocessing module 22 produces as output the audio recording 21 of the speech of the speaker's voice in preprocessed form, i.e. an audio signal of the speech of the speaker's voice, as preprocessed. This audio preprocessing module 22 is a non-trainable module.

Advantageously, the audio preprocessing module 22 comprises a trimming submodule 23a which removes the portions of silence at the ends, i.e. at the start and at the end, of the audio recording 21. This trimming module 23a is a non-trainable module.

Advantageously, the audio preprocessing module 22 comprises a resampling submodule 23b which resamples the audio recording 21 at a predetermined frequency, common to all the other audio recordings. For example, all the audio recordings can be resampled at 24 kHz. This resampling module 23b is a non-trainable module.

Advantageously, the audio preprocessing module 22 comprises a loudness normalization submodule 23c which normalizes the loudness of the audio recording 21 to a predefined value, common to all the other audio recordings. For example, all the audio recordings can be normalized to −21 dB. This loudness normalization module 23c is a non-trainable module.

In parallel with the steps, or operations, executed by the audio preprocessing module 22 and by the feature extractor module 24, the method according to the invention involves the steps, or operations, executed by a text preprocessing module 32 and by a linguistic encoder module 34.

A text preprocessing module 32 receives as input the target text 31 that the synthesized virtual voice is to recite, in the inference variant, or corresponding to the speech of the speaker's voice, in the training variant.

The text preprocessing module 32 produces as output the target text 31 in preprocessed form. This text preprocessing module 32 is a non-trainable module.

Advantageously, the text preprocessing module 32 comprises a cleaning submodule 33a which receives as input the target text 31, and corrects any typos present in the target text 21. For example, the typos in the target text 21 can be corrected on the basis of one or more predefined dictionaries.

The text preprocessing module 32 comprises a phonemizing submodule 33b which receives as input the target text 31, preferably cleaned by the cleaning module 33a, and transforms or converts this target text 31 to a corresponding sequence or string of phonemes. The phonetics, and therefore the pronunciation, of the target text 31 has a fundamental valency in the method according to the invention. Furthermore, there are only a few hundred phonetic symbols, therefore the domain to be handled is substantially small, while the number of words for each language is in the order of tens of thousands. For example, the phonemizing of the target text 31 can be executed by means of an open source repository named bootphon/phonemizer.

The phonemizing module 33b produces as output the sequence of phonemes of the target text 31. This phonemizing module 33b is a non-trainable module.

The text preprocessing module 32 comprises a tokenizing submodule 33c which receives as input the sequence or string of phonemes of the target text 31, produced by the phonemizing module 33b, and transforms or converts this sequence or string of phonemes of the target text 31 to a sequence of respective vectors, i.e. a vector for each phoneme, where each vector of the phoneme comprises a plurality of identifiers, or IDs, which define a plurality of respective linguistic features relating to the pronunciation of the specific phoneme of the target text 31. By virtue of this tokenizing, the pitch of the various words of the text can be controlled in the voice synthesizing process, which results in greater naturalness of the synthesized virtual voice.

The tokenizing module 33c produces as output the sequence of phoneme vectors of the target text 31, where each vector comprises a plurality of IDs. This tokenizing module 33c is a non-trainable module.

Preferably, the IDs comprised in the vectors of the phonemes of the target text 31, produced by the text preprocessing module 32, in particular by the tokenizing module 33c, can be selected from the group consisting of:
ID of the phoneme, or rather of the symbol of the phoneme;
ID of the phonetic stress, for the accent of the phoneme;
ID of the articulation, co-articulation, labialization and length, for the phonetic inflection of the phoneme;
ID of the text type, i.e. affirmative, exclamatory or interrogative;
ID of the text punctuation, for the type of pause contained in the text; and
ID of the pitch or tone of the word, specifically for the Chinese language.

A linguistic encoder module 34 receives as input the sequence of phoneme vectors of the target text 31, where each vector comprises a plurality of IDs, produced by the text preprocessing module 32, in particular by the tokenizing module 33c, and transforms or converts this sequence of phoneme vectors of the target text 31 to a sequence of respective linguistic latent vectors 35, wherein each linguistic latent vector represents a set of independent latent spaces.

The sequence of linguistic latent vectors 35 is a matrix (i.e. a 2-dimensional vector) produced and learned by the linguistic encoder module 34. Therefore, the same sequence can also be defined as a text latent representation matrix 35.

The linguistic encoder module 34 produces as output the sequence of linguistic latent vectors 35, i.e. the text latent representation matrix 35. This linguistic encoder module 34 is a trainable module which implements a deep learning algorithm.

Preferably, the independent latent spaces comprised in the linguistic latent vectors 35, produced by the linguistic encoder module 34, can be selected from the group consisting of:
phonetic embedding space: latent representation of the phoneme, or rather of the symbol of the phoneme;
phonetic stress space: latent representation of the accent of the phoneme;
articulation, co-articulation, labialization and length space: latent representation of the phonetic inflection of the phoneme;
text type space: latent representation of the type of text, i.e. affirmative, exclamatory or interrogative;
text punctuation space: latent representation of the type of pause contained in the text; and
Chinese tone space: latent representation of the pitch or tone of the phoneme, specifically for the Chinese language.

In an embodiment, in particular in the training variant of the method according to the invention, illustrated in FIGS. 2A and 2B, the method according to the invention entails the steps, i.e. the operations, executed by an audio-text alignment module 36.

The audio-text alignment module 36 receives as input the audio latent representation matrix 25, produced by the feature extractor module 24, and the sequence of linguistic latent vectors 35, i.e. the text latent representation matrix 35, produced by the linguistic encoder module 34. The audio-text alignment module 36 aligns over time the sequence of phonemes of the target text 31 with the audio latent representation, i.e. it indicates which phoneme of the target text 31 that each frame of the latent representation refers to, for example as shown in FIG. 5 by the trend 60 of the alignment for the pronunciation of the Italian phrase: “Ce l'abbiamo fatta. Vero?”.

The alignment module 36 produces as output at least one item of information about the alignment over time of the sequence of phonemes of the target text 31 with the audio latent representation matrix 25. This alignment module 36 is a trainable module which implements a deep learning algorithm.

In a preferred embodiment, the method according to the invention entails the steps, i.e. the operations, executed by a speech emotion and emission recognition module 27. It should be noted that recognizing emotions and/or emissions is equivalent to predicting them. It should also be noted that, in the present invention, the term “emotions” indicates the vocal expression of emotions, not psychological emotions.

The speech emotion and emission recognition module 27 receives as input the audio latent representation matrix 25, produced by the feature extractor module 24. The speech emotion and emission recognition module 27 makes it possible to transfer the emotions and/or the emissions of the speech of the speaker's voice of the audio recording 21, as per the audio latent representation matrix 25, to the synthesized virtual voice that is to recite the target text 31.

The speech emotion and emission recognition module 27 produces as output a plurality of emotion and emission signals 51, represented in the time domain and therefore intelligible, relating to the audio latent representation matrix 25. The output of the speech emotion and emission recognition module 27 is then fed as input to the acoustic model module 43, in order to increase the quality and naturalness of the synthesized virtual voice. This speech emotion and emission recognition module 27 is a trainable module which implements deep learning algorithms.

This speech emotion and emission recognition module 27 is a controllable module, that is to say that one or more emotion and emission signals 51, since they are represented in the time domain and therefore intelligible, can be modified, manipulated, constructed and/or combined by a human operator, for example by means of adapted commands entered by that human operator by means of the system 10 according to the invention. In particular, since each emotion and emission signal 51 can have a value comprised between 0 and 1 (or the like) for each instant in time, it is possible to control the emotions over time, i.e. the vocal expressions over time, and/or the emissions over time, as well as the respective intensities over time.

Advantageously, the plurality of emotion and emission signals 51 comprises a plurality of emotion signals 51a and/or a plurality of emission signals 51b, as described in the following paragraphs.

Advantageously, the speech emotion and emission recognition module 27 comprises an emotion predictor submodule 28a which predicts an emotional state of the speech of the synthesized virtual voice, on the basis of the audio latent representation matrix 25, in particular by mapping a continuous emotional space of the speech of the speaker's voice as per the audio latent representation matrix 25. This continuous emotional space is represented by a plurality of emotional signals 51a (one signal for each emotion) which have the same time dimension as the time dimension of the audio latent representation matrix 25.

The emotion predictor module 28a produces as output the plurality of emotion signals 51a, represented in the time domain, relating to the audio latent representation matrix 25. The continuous emotional space makes it possible to reproduce expressions and prosodies that never arose during training, making it so that the expressive complexity of the synthesized virtual voice can be as varied as possible. This emotion predictor module 28a is a trainable module (in particular it can be trained to recognize emotions), which implements a deep learning algorithm. This emotion predictor module 28a is a controllable module, according to what is described above with reference to the speech emotion and emission recognition module 27. As mentioned, one or more emotion signals 51a, since they are represented in the time domain and therefore intelligible, can be modified, manipulated, constructed and/or combined by a human operator, for example by means of adapted commands entered by that human operator by means of the system 10 according to the invention. In particular, since each emotion signal 51a can have a value comprised between 0 and 1 (or the like) for each instant in time, it is possible to control the emotions over time, i.e. the vocal expressions over time, as well as their intensities over time.

For example, the emotions represented by respective emotion signals, produced by the emotion predictor module 28a, can be selected from the group consisting of: Anger, Announcer, Contempt, Distress, Elation, Fear, Interest, Joy, Neutral, Relief, Sadness, Serenity, Suffering, Surprise (positive), Epic/Mystery.

This emotion predictor module 28a is trained so that it is independent of language and speaker, i.e. so that the emotional space maps only stylistic and prosodic features, and not voice timbre or linguistic features. By virtue of this independence, the emotion predictor module 28a makes it possible, given an audio recording of any speaker and in any language, to map that audio recording in the emotional space and use the plurality of emotional signals 51a to condition the acoustic model 43 in inference, in so doing transferring the style—or rather the emotion—of an audio recording to a text with any voice and in any language.

By virtue of the continuity of the emotional space, the emotion predictor module 28a makes it possible to create “gradients” between the emotions (known as emotional cross-fade) expressed by the speech, i.e. it can fade the speech from one emotion to another without brusque changes, thus rendering the speech much more natural and human.

Advantageously, the speech emotion and emission recognition module 27 comprises an emission predictor submodule 28b which predicts an emission intensity of the speech of the synthesized virtual voice, on the basis of the audio latent representation matrix 25, in particular by mapping a continuous emissive space of the speech of the speaker's voice as per the audio latent representation matrix 25, with continuous values where for example 0.1 means whispered and 0.8 means shouted. In particular, the emission predictor module 28b predicts the average emission of the speech, but also the emission over time of the speech, so as to be able to use this temporal information as input to the acoustic model 43. This continuous emissive space is represented by a plurality of emission signals 51b (one signal for each emission) which have the same time dimension as the time dimension of the audio latent representation matrix 25.

The emission predictor module 28b produces as output the plurality of emission signals 51b, represented in the time domain, relating to the audio latent representation matrix 25. The continuous emissive space makes it possible to reproduce emissions, or rather emissive intensities, that never arose during training, making it so that the emissive complexity of the synthesized virtual voice can be as varied as possible. This emission predictor module 28b is a trainable module which implements a deep learning algorithm. This emission predictor module 28b is a controllable module, according to what is described above with reference to the speech emotion and emission recognition module 27. As mentioned, one or more emission signals 51b, since they are represented in the time domain and therefore intelligible, can be modified, manipulated, constructed and/or combined by a human operator, for example by means of adapted commands entered by that human operator by means of the system 10 according to the 20) invention. In particular, since each emission signal 51b can have a value comprised between 0 and 1 (or the like) for each instant in time, it is possible to control the emissions over time, as well as their intensities over time.

For example, the emissions shown by respective emission signals, produced by the emission predictor module 28b, can be selected from the group consisting of: Whisper, Soft, Normal, Projected, Shouted.

In a preferred embodiment, the method according to the invention entails the steps, i.e. the operations, executed by a voice control module 29.

The voice control module 29 receives as input the audio latent representation matrix 25, produced by the feature extractor module 24. The voice control module 29 makes it possible to transfer the speaker's voice of the audio recording 21, as per the audio latent representation matrix 25, to the synthesized virtual voice that is to recite the target text 31.

The voice control module 29 produces as output a voice latent representation vector 52, in particular of the voice timbre of the synthesized virtual voice, relating to the audio latent representation matrix 25. This voice latent representation vector 52 is part of, and therefore derives from, a continuous voice space produced by the voice space conversion module 30a. The output of the voice control module 29 is then fed as input to the acoustic model module 43, in order to increase the quality and naturalness of the synthesized virtual voice. This voice control module 29 is a trainable module which implements deep learning algorithms.

This voice control module 29 is a controllable module, that is to say that the voice latent representation vector 52 can be modified, manipulated and/or constructed by a human operator, for example by means of adapted commands entered by that human operator by means of the system 10 according to the invention.

Advantageously, the voice control module 29 comprises a voice space conversion submodule 30a which passes from a discrete voice space (a finite number of speakers, and therefore of voice timbres, seen during training), defined by the audio latent representation matrix 25, to a continuous voice space. This is possible by virtue of the use of variational autoencoder (VAE) architectures, which represent the space continuously by means of Gaussian sampling of the latent space.

The voice space conversion module 30a produces as output a continuous voice space relating to the audio latent representation matrix 25. This voice space conversion module 30a is a trainable module which implements a deep learning algorithm.

Advantageously, the voice control module 29 comprises a voice space mapping submodule 30b which receives as input the continuous voice space, produced by the voice space conversion module 30a, and creates a vector that represents the voice timbre of the synthesized virtual voice.

The voice space mapping module 30b produces as output a voice latent representation vector 52, in particular of the voice timbre of the synthesized virtual voice, relating to the audio latent representation matrix 25. This voice space mapping module 30b is a trainable module which implements a deep learning algorithm. This voice space mapping module 30b is a controllable module, according to what is described above with reference to the voice control module 29. As mentioned, the voice latent representation vector 52 can be modified, manipulated and/or constructed by a human operator, for example by means of adapted commands entered by that human operator by means of the system 10 according to the invention.

The voice space mapping module 30b makes it possible, given two audio recordings of two different speakers, to synthesize a virtual voice that is a middle ground, weighted or non-weighted, of the voices of the two speakers (referred to as speaker interpolation).

The voice space mapping module 30b makes it possible to generate completely virtual voices, i.e. voices not based on the voice of a speaker learned during training (no voice cloning), using as a control some physical voice timbre and speaker features, for example pitch (tone) F₀, age, sex and height. In particular, this module executes a mapping between the continuous voice space and these physical features. It is therefore possible to sample completely virtual voices from the continuous voice space, given a combination (even partial) of the physical features. For example, it is possible to sample a synthesized virtual voice that is male and with a pitch (tone) comprised between 180 Hz and 200 Hz.

In a preferred embodiment, the method according to the invention entails the steps, i.e. the operations, executed by a duration control module 40.

In the inference variant of the method according to the invention, illustrated in FIGS. 1A and 1B, the duration control module 40 can receive as input an association, preferably a concatenation, between the audio latent representation matrix 25, produced by the feature extractor module 24, and the sequence of linguistic latent vectors 35, produced by the linguistic encoder module 34.

In the training variant of the method according to the invention, illustrated in FIGS. 2A and 2B, the duration control module 40 can receive as input the information about the alignment over time of the sequence of phonemes of the target text 31 with the audio latent representation, produced by the alignment module 36.

The duration control module 40 defines the duration of each individual phoneme of the linguistic latent vectors 35, and therefore of the target text 31, where the sum of the durations of the individual phonemes is equal to the length/duration of the predicted audio latent representation 44. It should be noted that the duration of each individual phoneme influences the prosody, the naturalness and the expressive style of the speech of the synthesized virtual voice.

The duration control module 40 produces as output a sequence of phoneme durations 53 of the linguistic latent vectors 35, and therefore of the target text 31. The output of the duration control module 40 is then fed as input to the acoustic model module 43, in order to increase the quality and naturalness of the synthesized virtual voice. This duration control module 40 is a trainable module which implements deep learning algorithms.

Advantageously, the duration control module 40 comprises a duration predictor submodule 41 which receives as input an association, preferably a concatenation, between the audio latent representation matrix 25, produced by the feature extractor module 24, and the sequence of linguistic latent vectors 35, produced by the linguistic encoder module 34. The duration predictor module 41 predicts the respective durations of the phonemes 53 of the linguistic latent vectors 35, and therefore of the target text 31 recited by the synthesized virtual voice, and as a consequence the length/duration of the predicted audio latent representation 44. The prediction of the durations of the phonemes 53 of the linguistic latent vectors 35, and therefore of the target text 31, is based on their linguistic context, i.e. defined by the linguistic features, and optionally is based on one or more acoustic features, for example emotion and emission.

The duration predictor module 41 produces as output a sequence of phoneme durations 53 of the linguistic latent vectors 35, and therefore of the target text 31 recited by the synthesized virtual voice. This duration predictor module 41 is a trainable module which implements a deep learning algorithm.

Preferably, the prediction of the duration of a phoneme is divided into three separate predictions: prediction of the normalized distribution of the duration, prediction of the average of the duration, and prediction of the standard deviation of the duration. In practice, instead of predicting the duration of each phoneme, the duration predictor module 41 predicts its normalized distribution, its average and its standard deviation.

Preferably, the duration predictor module 41 is trained by means of instance normalization with different datasets for each one of the three predictions (normalized distribution, average, and standard deviation).

In a preferred embodiment, in particular in the inference variant of the method according to the invention, illustrated in FIGS. 1A and 1B, the method according to the invention entails the steps, i.e. the operations, executed by a signal control module 38.

The signal control module 38 can receive as input an association, preferably a concatenation, between the sequence of linguistic latent vectors 35, produced by the linguistic encoder module 34, the plurality of emotion and emission signals 51, produced by the speech emotion and emission recognition module 27, optionally the voice latent representation vector 52, produced by the voice control module 29, and optionally the sequence of phoneme durations 53 of the linguistic latent vectors 35, and therefore of the target text 31, produced by the duration control module 40. In practice, the signal control module 38 receives as input a set of acoustic and linguistic features.

The signal control module 38 produces as output a plurality of pitch and energy signals 54, represented in the time domain, relating to the audio latent representation matrix 25. The output of the signal control module 38 is then fed as input to the acoustic model module 43, in order to increase the quality and naturalness of the synthesized virtual voice. This signal control module 38 is a trainable module which implements deep learning algorithms.

Advantageously, the signal control module 38 comprises a pitch predictor submodule 39a which predicts a pitch, or “tonal height”, i.e. a fundamental frequency F₀, for every frame of the audio latent representation matrix 25. In particular, the prediction of the pitch is based both on the linguistic features comprised in, or represented by, the sequence of linguistic latent vectors 35, and on the acoustic features comprised in, or represented by, the plurality of emotion and emission signals 51, optionally the voice latent representation vector 52, and optionally the sequence of phoneme durations 53 of the linguistic latent vectors 35, and therefore of the target text 31.

The pitch predictor module 39a produces as output a plurality of pitch signals 54 (one signal for every frame) relating to the audio latent representation matrix 25. This pitch predictor module 39a is a trainable module which implements a deep learning algorithm.

In general, although the representations of the various acoustic features, which are obtained from the audio latent representation matrix 25, can be independent, it is substantially impossible to completely eliminate the risk of leakage of information, i.e. the presence of unwanted information, for example the plurality of emotion and emission signals 51 could also contain information about the speaker's voice on the audio recording 21.

Preferably, in order to minimize this leakage of information, the prediction of the pitch is divided into three separate predictions: prediction of the normalized distribution of the pitch, prediction of the average of the pitch, and prediction of the standard deviation of the pitch. In practice, instead of predicting the pitch signal, the pitch predictor module 39a predicts its normalized distribution, its average and its standard deviation.

At the physical level, the normalized distribution of the pitch signal is a representation of the prosody of the speech, independent of the speaker, while the average represents the pitch of the speaker's voice. The acoustic features are used to predict the normalized distribution. The continuous voice space produced by the voice control module 29 is used to predict the average. The linguistic features, in particular the sequence of phonemes of the target text 31, produced by the phonemizing module 33b, are used to predict the standard deviation. A prediction of the normalized distribution of the pitch that depends only on prosodic and linguistic features, and a prediction of the average that depends only on features relating to the speaker, creates a prediction that is even more independent between style and voice, so increasing even more the control between speaker and emotion.

Preferably, the pitch predictor module 39a is trained by means of instance normalization with different datasets for each one of the three predictions (normalized distribution, average, and standard deviation).

Advantageously, the signal control module 38 comprises an energy predictor submodule 39b which predicts a magnitude for each frame of the audio latent representation matrix 25. In particular, the prediction of the energy or magnitude is based both on the acoustic features comprised in, or represented by, the plurality of emotion and emission signals 51, optionally the voice latent representation vector 52, and optionally the sequence of phoneme durations 53 of the linguistic latent vectors 35, and therefore of the target text 31, and also on the linguistic features comprised in, or represented by, the sequence of linguistic latent vectors 35.

The energy predictor module 39b produces as output a plurality of energy signals 54 (one signal for every frame) relating to the audio latent representation matrix 25. This energy predictor module 39b is a trainable module which implements a deep learning algorithm.

In an embodiment, in particular in the training variant of the method according to the invention, illustrated in FIGS. 2A and 2B, the method according to the invention furthermore has, as input, a plurality of real pitch and real energy signals 56, represented in the time domain, relating to the audio recording 21. The plurality of real pitch and real energy signals 56 is fed as input to the acoustic model module 43, in order to increase the quality and naturalness of the synthesized virtual voice.

The plurality of real pitch and real energy signals 56 is an input independent of the set of the acoustic and linguistic features and comprises the sequence of linguistic latent vectors 35, produced by the linguistic encoder module 34, the plurality of emotion and emission signals 51, produced by the speech emotion and emission recognition module 27, the voice latent representation vector 52, produced by the voice control module 29, and the sequence of phoneme durations 53 of the linguistic latent vectors 35, and therefore of the target text 31, produced by the duration control module 40. The real pitch and real energy signals 56 are extracted directly from the waveform of the audio recording 21 with signal processing techniques.

In practice, the real values are used in the training variant, while the predicted values are used in the inference variant.

An acoustic model module 43 can receive as input, and therefore be conditioned by, an association, preferably a concatenation, between the sequence of linguistic latent vectors 35, produced by the linguistic encoder module 34, the plurality of emotion and emission signals 51, produced by the speech emotion and emission recognition module 27, the voice latent representation vector 52, produced by the voice control module 29, and the sequence of phoneme durations 53 of the linguistic latent vectors 35, and therefore of the target text 31, produced by the duration control module 40. Furthermore, in the case of the inference variant, the association or the concatenation mentioned above further comprises the plurality of pitch and energy signals 54, produced by the signal control module 38. Alternatively, in the case of the training variant, the association or the concatenation mentioned above further comprises the plurality of real pitch and real energy signals 56, received as input. In practice, the acoustic model module 43 receives as input a set of acoustic and linguistic features.

The acoustic model module 43 predicts a latent representation of an audio signal over time of the speech of the synthesized virtual voice, on the basis of the set of acoustic and linguistic features in input, producing as output a predicted audio latent representation matrix 44 over time. In practice, the acoustic model module 43 predicts the audio signal over time of the speech of the synthesized virtual voice. Therefore, for brevity, the audio signal of the speech of the synthesized virtual voice is also indicated with the expression “predicted audio”. This acoustic model module 43 is a trainable module which implements a deep learning algorithm. For example, this acoustic model module 43 can be of the Seq2Seq decoder type.

The prediction of the latent representation of the audio signal of the speech of the synthesized virtual voice, and therefore that very predicted signal, comprises acoustic features deriving from the audio recording (source speech) 21 and linguistic features deriving from the target text 31.

By virtue of the feature extractor module 24, which produces the audio latent representation matrix 25 of the audio recording 21, and the linguistic encoder module 34, which produces the sequence of linguistic latent vectors 35, as well as by virtue of the subsequent modules 27, 29, 40 and 38, which produce the other acoustic and linguistic features, the acoustic model module 43 is capable of predicting the latent representation matrix 44 of the audio signal of the speech of the synthesized virtual voice. This predicted audio latent representation 44, having a continuous structure and being learned from other modules, which implement other algorithms, is easier to predict, leading to faster training and higher output quality.

Advantageously, for the purpose of maximizing the quality, the control and the expressiveness of the speech of the synthesized virtual voice, the acoustic model module 43 can be conditioned by all the features listed above. In this case, all the features listed above can be associated, preferably concatenated, with each other, thus forming the at least one vector of codified and conditional features 42.

As mentioned, although the representations of the various acoustic features, which are obtained from the audio latent representation matrix 25, 20) can be independent, they are subject to the risk of leakage of information, i.e. the presence of unwanted information, for example the plurality of emotion and emission signals 51 could also contain information about the speaker's voice on the audio recording 21.

In an embodiment, in order to minimize this information leakage, the acoustic model module 43 can be conditioned only by the plurality of pitch and energy signals 54, produced by the signal control module 38.

A vocoder module 45 receives as input the predicted audio latent representation matrix 44, produced by the acoustic model module 43, and converts, or rather decodes, this predicted audio latent representation matrix 44 into the corresponding audio signal of the speech of the synthesized virtual voice (synthesized audio) 46. This vocoder module 45 is a trainable module which implements a deep learning algorithm. Preferably, the vocoder module 45 uses conventional vocoding architectures based mainly on MelGAN (Generative Adversarial Networks for Conditional Waveform Synthesis). For example, this vocoder module 45 can be of the UnivNet type.

Preferably, the audio signal of the speech of the synthesized virtual voice 46, before being emitted externally, can be processed by an audio postprocessing module 47.

The audio postprocessing module 47 receives as input the audio signal of the speech of the synthesized virtual voice 46, produced by the vocoder module 45. The audio postprocessing module 47 produces as output the audio signal of the synthesized virtual voice in postprocessed form (target audio) 49, i.e. an audio signal of the synthesized virtual voice 49, as postprocessed. This audio postprocessing module 47 is a non-trainable module.

Advantageously, the audio postprocessing module 47 comprises a virtual studio submodule 48a which creates a virtual recording environment, based on the characteristics of a virtual room (dimensions of the room, distance from the microphone, etc.), in which to simulate the recording of the speech of the synthesized virtual voice. This virtual studio module 48a is a non-trainable module.

Advantageously, the audio postprocessing module 47 comprises a virtual microphone submodule 48b which creates a virtual microphone from which to simulate the recording of the speech of the synthesized virtual voice. This virtual microphone module 48b is a non-trainable module.

Advantageously, the audio postprocessing module 47 comprises a loudness normalization submodule 48c which normalizes the loudness of the audio signal of the speech of the synthesized virtual voice 46 to a predefined value, common to all the other audio recordings. For example, all the audio recordings can be normalized to −21 dB. This loudness normalization module 48c is a non-trainable module.

It should be noted that the trainable modules described above, in particular the feature extractor module 24, the linguistic encoder module 34, the speech emotion and emission recognition module 27 (and corresponding submodules), the voice control module 29 (and corresponding submodules), the duration control module 40 (and corresponding submodules), the signal control module 38 (and corresponding submodules), the acoustic model module 43 and the vocoder module 45, are stand-alone modules, i.e. they have a specific function, for example learning specific acoustic or linguistic features. In other words, these modules are defined as stand-alone because each one is trained separately, and potentially with different data.

This separation of functions is a great advantage for the development and training of these modules. For example, for training, an acoustic model module needs an audio dataset of exceptionally high quality, transcribed, with many speakers, a great deal of expressive variation and all the languages that the system is to support. These requirements considerably reduce the amount of available data that can be used for training. When training the modules all together, the greatly reduced dataset must compulsorily be used for training every module. But with separate training, each module can use the dataset that is most suitable for its training.

Advantageously, the training of these modules is executed using a dataset that has four principal characteristics: a plurality of speakers (multi-voice), a plurality of languages (multi-language), a wide expressive (emotional) spectrum, and high audio recording quality.

In creating this dataset, the definition of the emotions at the behavioral/psychological level, necessary for the subsequent pairing between these behavioral/psychological emotions and respective vocal expressiveness, can be based on Plutchik's wheel of emotions. Plutchik's wheel of emotions is a circular map that defines one neutral emotion, eight primary emotions, each of which is divided into three emotions that differ in intensity, and eight intra-emotions, i.e. emotional gradients between one primary emotion and another. Therefore, Plutchik's wheel of emotions defines thirty-three emotions overall.

However, it should be noted that a behavioral/psychological emotion does not have a one-to-one relationship with a specific vocal expressiveness. In other words, the same behavioral/psychological emotion can be expressed with different vocalisms, and two different behavioral/psychological emotions can be expressed with the same vocalism (for example anguish and fear).

In an embodiment, the pairing between behavioral definition of emotions and vocal definition of emotions is mapped using the following table, where the vocal emotional classes in the right-hand column express Plutchik's behavioral/psychological emotions in the left-hand column. It should be noted that, in the table shown below, the rows that have no entry in the column for Plutchik's behavioral emotions refer to those forms of vocal expressiveness that do not have a corresponding, clearly-associable vocal emotional class. It should also be noted that, for the sake of simplification, Plutchik's eight intra-emotions have been removed and Plutchik's two behavioral/psychological emotions (admiration and distraction) have not been assigned to any vocal emotional class.

| PLUTCHIK'S BEHAVIORAL | VOCAL EMOTIONAL |
|---|---|
| EMOTIONS | CLASSES |
| Anger, Rage | Anger |
| Boredom, Annoyance | Complaint |
| Anger | Contempt |
| Anticipation, Vigilance, Fear | Distress |
| Ecstasy | Elation |
| Terror | Fear |
| Interest | Interest |
| Joy, Trust | Joy |
| Neutral | Neutral |
| Sadness, Pensiveness, Grief | Sadness |
| Acceptance, Serenity | Serenity |
| Disgust, Loathing | Suffering |
| Awe | Surprise (negative) |
| Amazement, Surprise | Surprise (positive) |
| — | Believable |
| — | Lust |
| — | Relief |
| — | Epic/Mystery |
| — | Announcement |

The present invention also relates to a synthesized speech digital audio content obtained or obtainable by means of the steps described above of the method for producing synthesized speech digital audio content.

With particular reference to FIG. 4, the present invention also relates to a data processing system or device, in short a computer, generally designated by the reference numeral 10, that comprises modules configured to execute the steps described above of the method for producing synthesized speech digital audio content according to the invention. Furthermore, the system 10 further comprises a processor and a memory (not shown).

The present invention also relates to a computer program comprising instructions which, when the program is run by a computer 10, cause the computer 10 to execute the steps described above of the method for producing synthesized speech digital audio content according to the invention.

The present invention also relates to a computer-readable memory medium comprising instructions which, when the instructions are run by a computer 10, cause the computer 10 to execute the steps described above of the method for producing synthesized speech digital audio content according to the invention.

In practice it has been found that the present invention fully achieves the set aim and objects. In particular, it has been seen that the method and the system for producing synthesized speech digital audio content thus conceived make it possible to overcome the qualitative limitations of the known art, in that they make it possible to obtain better effects than those that can be obtained with conventional solutions and/or similar effects at lower cost and with higher performance levels.

An advantage of the method and of the system for producing synthesized speech digital audio content according to the present invention consists in that they make it possible to create acoustic and linguistic features optimized for the acoustic model, as well as to create optimized audio representation matrices.

Another advantage of the method and of the system for producing synthesized speech digital audio content according to the present invention consists in that they make it possible to synthesize a virtual voice while maximizing the expressiveness and naturalness of that virtual voice.

Another advantage of the method and of the system for producing synthesized speech digital audio content according to the present invention consists in that they make it possible, given an audio recording of a source voice, even of short duration (a few seconds), to imitate the expressiveness of the source voice, in practice transferring the style of the source voice to the synthesized virtual voice.

Another advantage of the method and of the system for producing synthesized speech digital audio content according to the present invention consists in that they make it possible, given an audio recording of a source voice, even of short duration (a few seconds), to create a completely synthesized voice that reflects the main features of the source voice, in particular of its voice timbre.

Another advantage of the method and of the system for producing synthesized speech digital audio content according to the present invention consists in that they have multilingual capability, i.e, wherein every synthesized virtual voice can speak in every supported language.

In the practice of dubbing, the method and the system for producing synthesized speech digital audio content according to the invention can be used for:
emotional dubbing: given an audio recording of a source voice in the original language and its translations in other supported languages, the system will be able to synthesize substantially instantaneously the supplied translations in the other languages, reflecting the expressiveness and the principal features of the source voice;
voice expansion: given an audio recording of a voice X, the system will be able to recreate the same speech in the same language but with a set of voices other than X, all completely synthesized; and/or
line expansion: given an audio recording of a voice X with expressiveness Y and text T₀ in a language L, the system will be able to synthesize texts T₁, T₂, . . . , T_{N} in language L, following the voice X and the expressiveness Y.

Although the method and the system for producing synthesized speech digital audio content according to the invention have been conceived in particular for dubbing operations, they can in any case be used more generally for any type of audio production.

The invention, thus conceived, is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

In conclusion, the scope of protection of the claims shall not be limited by the explanations or by the preferred embodiments illustrated in the description by way of examples, but rather the claims shall comprise all the patentable characteristics of novelty that reside in the present invention, including all the characteristics that would be considered as equivalent by the person skilled in the art.

The disclosures in Italian Patent Application No. 102022000019788 from which this application claims priority are incorporated herein by reference.

1-13. (canceled)

14. A method for producing synthesized speech digital audio content, comprising steps wherein:
a feature extractor module receives as input an audio recording of a speaker's voice, extracts a plurality of acoustic features from said audio recording, and converts said acoustic features to an audio latent representation matrix;
a phonemizing module of a text preprocessing module receives as input a target text and converts said target text to a sequence of phonemes;
a tokenizing module of said text preprocessing module receives as input said sequence of phonemes of said target text and converts said sequence of phonemes to a sequence of respective vectors of the phonemes of said target text, wherein each vector comprises a plurality of IDs that define a plurality of respective linguistic features of the phoneme of said target text;
a linguistic encoder module receives as input said sequence of phoneme vectors of said target text and converts said sequence of phoneme vectors to a sequence of respective linguistic latent vectors, wherein each vector represents a set of independent latent spaces;
an emotion predictor module of a speech emotion and emission recognition module receives as input said audio latent representation matrix, predicts an emotional state of the speech of a synthesized virtual voice, and produces as output a plurality of emotion signals in the time domain;
an emission predictor module of said speech emotion and emission recognition module receives as input said audio latent representation matrix, predicts an emission intensity of the speech of said synthesized virtual voice, and produces as output a plurality of emission signals in the time domain;
an acoustic model module receives as input said sequence of linguistic latent vectors and said plurality of emotion and emission signals in the time domain, predicts a latent representation of an audio signal of the speech of said synthesized virtual voice, and produces as output a predicted audio latent representation matrix; and
a vocoder module receives as input said predicted audio latent representation matrix and decodes said predicted audio latent representation matrix into said audio signal of the speech of said synthesized virtual voice.

15. The method for producing synthesized speech digital audio content according to claim 14, further comprising the step wherein:
a voice space conversion module of a voice control module receives as input said audio latent representation matrix, and passes from a discrete voice space, defined by said audio latent representation matrix, to a continuous voice space, related to said audio latent representation matrix; and
a voice space mapping module of said voice control module receives as input said continuous voice space, related to said audio latent representation matrix, and creates a voice latent representation vector, which representing the voice timbre of said synthesized virtual voice:
wherein said acoustic model module further receives as input said voice latent representation vector.

16. The method for producing synthesized speech digital audio content according to claim 14, further comprising the step wherein:
a duration predictor module of a duration control module receives as input said audio latent representation matrix and said sequence of linguistic latent vectors, predicts respective durations of the phonemes of said linguistic latent vectors, and produces as output a sequence of phoneme durations of said linguistic latent vectors;
wherein said acoustic model module further receives as input said sequence of phoneme durations.

17. The method for producing synthesized speech digital audio content according to claim 14, further comprising the step wherein:
a pitch predictor module of a signal control module receives as input said sequence of linguistic latent vectors, said plurality of emotion and emission signals, optionally said voice latent representation vector, and optionally said sequence of phoneme durations, predicts a pitch for each frame of said audio latent representation, and produces as output a plurality of pitch signals in the time domain;
wherein said acoustic model module further receives as input said plurality of pitch signals.

18. The method for producing synthesized speech digital audio content according to claim 14, further comprising the step wherein:
an energy predictor module of a signal control module receives as input said sequence of linguistic latent vectors, said plurality of emotion and emission signals, optionally said voice latent representation vector, and optionally said sequence of phoneme durations, predicts a magnitude for each frame of said audio latent representation, and produces as output a plurality of energy signals in the time domain;
wherein said acoustic model module further receives as input said plurality of energy signals.

19. The method for producing synthesized speech digital audio content according to claim 14, further comprising the step wherein:
a trimming module of an audio preprocessing module receives as input said audio recording and removes portions of silence at the ends of said audio recording.

20. The method for producing synthesized speech digital audio content according to claim 14, further comprising the step wherein:
a resampling module of an audio preprocessing module receives as input said audio recording and resamples said audio recording at a predetermined frequency.

21. The method for producing synthesized speech digital audio content according to claim 14, further comprising the step wherein:
a loudness normalization module of an audio preprocessing module receives as input said audio recording and normalizes the loudness of said audio recording to a predefined value.

22. The method for producing synthesized speech digital audio content according to claim 14, further comprising the step wherein:
a cleaning module of said text preprocessing module receives as input said target text and corrects typos present in said target text.

23. A synthesized speech digital audio content, obtainable by means of a method for producing synthesized speech digital audio content according to claim 14.

24. A system for producing synthesized speech digital audio content comprising modules configured to perform the steps of the method for producing synthesized speech digital audio content according to claim 14.
